(19) United States
(12) Patent Application Publication
(10) Pub. No.: US 2004/0000579 A1
(43) Pub. Date: Jan. 1, 2004

(54) Forming contact arrays on substrates

(76) Inventors: Robert M. Fuerst, West Bloomfield, MI (US); David A. Pfaffinger, Holly, MI (US)

Correspondence Address: MOLEX INCORPORATED, 2222 WELLINGTON COURT, LISLE, IL, 60532, US

(21) Appl. No.: 10/186,774

(22) Filed: Jul. 1, 2002

(51) Int. Cl. B23K 31/02

(52) U.S. Cl. 228/180.22

(57) ABSTRACT

An electrical device includes a flat flexible insulating substrate having an opening therethrough. A flat conductive terminal is deposited on one side of the substrate at the opening. A portion of the terminal is formed through the opening so that the terminal has opposite ends at opposite sides of the substrate. One end of the terminal forms a contact portion thereof, and an opposite end of the terminal forms a land portion for receiving a solder ball.

### FIELD OF THE INVENTION

This invention generally relates to the art of electrical connectors and, particularly, to the mounting of terminals on a flat flexible insulating substrate.

### BACKGROUND OF THE INVENTION

Solder ball grid arrays (BGA's) and land grid arrays (LGA's) are used in various electrical devices, such as electrical sockets, to provide a massive array of terminals or contacts in a small space. There may be as many as 2,000 terminals or contacts in a given LGA electrical socket. The terminals are provided on a substrate, and the terminals typically are stamped from sheet metal material or fabricated of small segments of wire and attached to the substrate. Each terminal has a land to which a solder ball can be attached. This provides a high density solder ball grid array to facilitate mass termination of the terminals to other terminals or contacts. The complexity of assembling such a quantity of tiny components causes these products to be relatively expensive to produce.

Attempts have been made to eliminate the individual terminals by utilizing flexible circuit technology, but such attempts have used integrally molded silicone rubber pads or the like to provide sufficient normal forces for the individual terminals or contacts. Because of the high compression stress relaxation properties of silicone rubber, such designs require excessive normal forces throughout the life of the product, thereby complicating the mechanical design of electrical sockets using such systems.

The present invention is directed to solving these problems by using flexible circuit technology but using unique designs for forming the terminals on a flat flexible circuit.

### SUMMARY OF THE INVENTION

An object, therefore, of the invention is to provide a new and improved electrical device with high density terminals on a flat insulating substrate.

Another object of the invention is to provide a new and improved method of fabricating such electrical devices.

In the exemplary embodiment of the invention, a flat flexible insulating substrate has an opening therethrough. A flat conductive terminal is deposited on one side of the substrate at the opening. A portion of the terminal is formed through the opening so that the terminal has opposite ends at opposite sides of the substrate. One end forms a contact portion of the terminal, and an opposite end forms a land portion for receiving a solder ball.

As disclosed herein, the contact portion of the terminal may be bifurcated to provide redundant contact means. A solder ball may be attached to the land portion of the terminal to provide an electrical device completely ready for termination. Preferably, at least the one end of the terminal comprising the contact portion is fabricated of spring alloy metal material.

In one embodiment of the invention, one of the opposite ends of the terminal is located on the one side of the substrate adjacent the opening. This one end comprises the land portion of the terminal. The opposite end of the terminal extends through the opening and projects away from an opposite side of the substrate. This opposite end comprises the contact portion of the terminal.

In another embodiment of the invention, the terminal includes a central portion between the opposite ends thereof. The central portion is adhered to the one side of the substrate. The opposite ends of the terminal project away from opposite sides of the substrate. In order to achieve this configuration, the flexible substrate is folded in the area of the central portion adjacent an edge of the opening to cause one end of the terminal to project from the one side of the substrate and an opposite end of the terminal to project through the opening beyond an opposite side of the substrate. A second flat substrate is adhered to the flat flexible substrate to maintain the folded area thereof. The end of the terminal projecting from the one side of the substrate comprises the contact portion of the terminal. The opposite end of the terminal extending through the opening comprises the land portion of the terminal.

The invention also contemplates methods of fabricating the electrical devices described above. Specifically, after the flat conductive terminal is deposited on one side of the flat flexible insulating substrate, a portion of the substrate is removed to form the opening beneath at least one end of the terminal. That one end then is formed through the opening so that opposite ends of the terminal are located at opposite sides of the substrate.

In the one embodiment of the invention described above, at least the one end of the terminal is fabricated with multi-metallic thicknesses of different stress coefficients so that the one end bends through the opening automatically on removing the portion of the substrate to form the opening.

In the second embodiment of the invention described above, portions of the substrate are removed to form two openings beneath opposite ends of the terminal, whereby folding the flat flexible circuit is effective to project opposite ends of the terminal through the two openings away from opposite sides of the substrate.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is perspective view of a portion of an electrical device according to a first embodiment of the invention;

FIG. 2 is a top plan view of the device of FIG. 1;

FIG. 3 is a side elevational view of the device;

FIG. 4 is a side elevational view looking toward the right-hand side of FIG. 3;

FIG. 5 is a perspective view of an electrical device according to a second embodiment of the invention;

FIG. 6 is a top plan view of the device of FIG. 5;

FIG. 7 is a side elevational view of the device of FIGS. 5 and 6;

FIG. 8 is a side elevational view looking toward the left-hand side of FIG. 7; and

FIGS. 9A-9F are sequential views illustrating the method of fabricating the device of FIGS. 5-8.

### DETAILED DESCRIPTION OF THE PREFERRED EMBODIMENTS

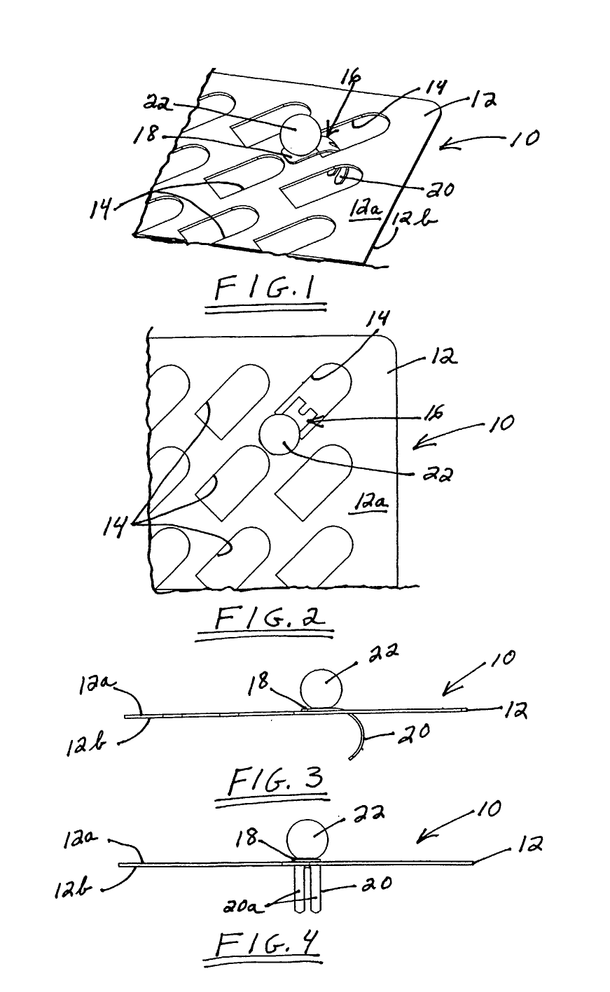

Referring to the drawings in greater detail, and first to FIGS. 1-4, a first embodiment of the invention is incorporated in an electrical device, generally designated 10, which includes a flat flexible insulating substrate 12 fabricated of such material as polyimide. A 5 plurality of openings 14 are formed through the substrate. A flat conductive terminal, generally designated 16, is deposited on one side 12a of the substrate in conjunction with each opening 14.

At this point, it should be understood that only one corner of the flat flexible insulating substrate 12 is shown in the drawings. As stated in the “Background”, above, a solder ball grid array in an electrical socket may include as many as 2,000 terminals or contacts. In such an application, that means that electrical device 10 would include 2,000 openings 14 and a corresponding 2,000 terminals 16. However, for simplicity purposes herein, and in order to provide drawing depictions which are not unnecessarily cluttered, only a portion of substrate 12 is shown and only a single terminal 16 is shown in conjunction with one of the openings. It is to be understood that one terminal 16 will be deposited on side 12a of substrate 12 for each of the many openings therein.

With that understanding, terminal 16 has one end 18 located on side 12a of substrate 12. An opposite end 20 of the terminal projects through its respective opening 14 beyond an opposite side 12b of the substrate. The one end 18 is formed as a land portion to which a solder ball 22 is attached. The opposite end 20 forms a contact portion of the terminal. As seen best in FIG. 4, contact end 20 is bifurcated to provide redundant contacts 20a.

In fabricating device 10, flat flexible insulating substrate 12 is provided of such material as polyimide. A plurality of flat conductive terminals 16 then are deposited on side 12a of the substrate by one of a variety of processes. For instance, the terminals can be individually electroplated onto side 12a of the substrate. The entire side of the substrate could be covered with metal material, then defined by a photodeposition process which subsequently is etched to leave the individual flat terminals.

After the flat terminals are deposited on side 12a of flat flexible substrate 12, openings 14 are formed in the substrate. This step can be performed by one of a number of processes such as chemically dissolving the substrate to selectively form the openings. Laser processes can be used to form the openings with efficiency.

After openings 14 are formed in substrate 12, contact portions or ends 20 of terminals 16 are formed through the openings so that they project beyond side 12b of the substrate, while land portions or ends 18 of the terminals remain on side 12a of the substrate. A unique concept of the invention is to form terminals 16 with multi-metallic thicknesses of different stress coefficients, sort of like a bimetallic spring. Such a differential stress plating process is designed so that contact portion or end 20 of each terminal automatically bends through its respective opening 14 upon removing the portion of substrate 12 which forms the opening. Therefore, end 20 of terminal 16 is formed as a spring contact portion with redundant contacts, requiring no additional or extraneous spring components.

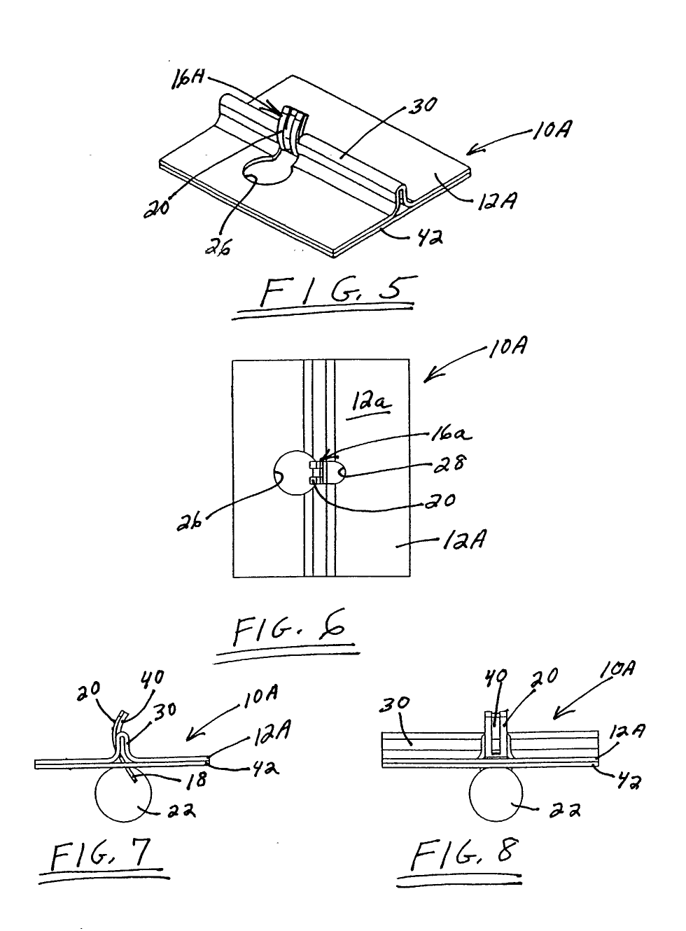

A second embodiment of an electrical device, generally designated 10A, is shown in FIGS. 5-8. Like device 10, device 10A includes a flat flexible insulating substrate 12A having a plurality of flat conductive terminals, generally designated 16A, deposited thereon. Again, each terminal includes a land end 18 for receiving a solder ball 22, and a bifurcated contact end 20. Referring to FIG. 6 and as described in greater detail hereinafter, land end 18 is formed out of an opening 26 in substrate 12A, and contact end 20 is formed out of an opening 28.

Like the first embodiment of FIGS. 1-4, the depiction of the second embodiment in FIGS. 5-8 shows only a single terminal 16A deposited on substrate 12A. However, it again should be understood that many terminals may be deposited on the substrate and formed thereon in device 10A.

FIGS. 5-8 show that substrate 12A of device 10A includes an inverted U-shaped fold 30. This fold is effective to cause land end or portion 18 and contact end or portion 20 of the terminal to project from opposite sides of the substrate as seen best in FIG. 7.

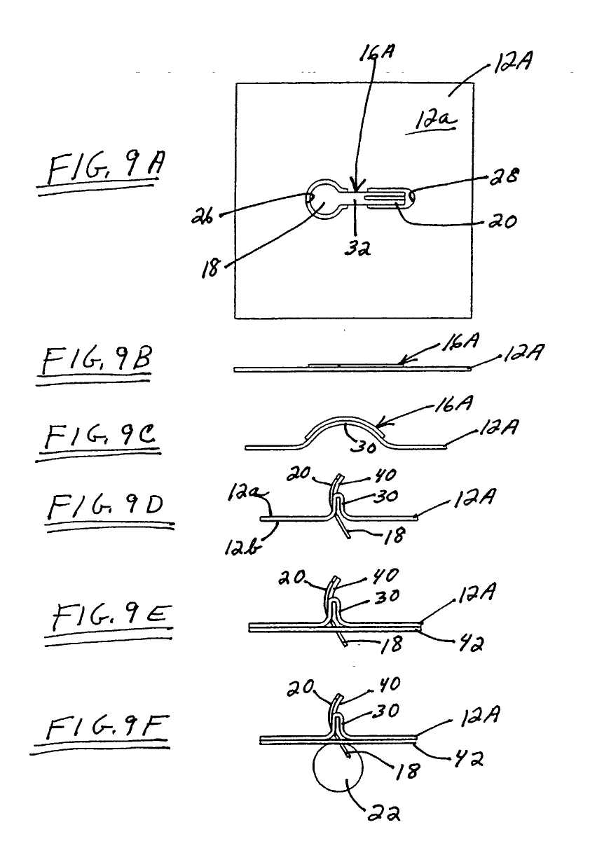

FIGS. 9A-9F show sequential steps in fabricating device 10A according to the second embodiment of the invention. Specifically, FIGS. 9A and 9B show that flat flexible insulating substrate 12A is provided, such as of polyimide material. Flat conductive terminals 16A are deposited on side 12a of the substrate. The terminals may be deposited by electroplating or photodeposition processes or the like. Each terminal includes land portion 18 at one end thereof and bifurcated contact portion 20 at an opposite end thereof. In addition, a central portion 32 is provided between the opposite end portions.

The next step is to form an opening 26 behind land portion 18 of each terminal, and to form an opening or cutout 28 around contact portion 20 of the terminal. These openings or cutouts can be formed by such processes as chemical etching, laser removal or the like, as described above in relation to the first embodiment of the invention.

The next step in fabricating device 10A is shown in FIGS. 9C and 9D. It can be seen that fold 30 is formed in flat flexible substrate 12A, with central portion 32 (FIG. 9A) of the terminal still attached to one side of the fold (the left-hand side as viewed in FIG. 9D). This causes land portion or end 18 of the terminal to move downwardly through opening 26 and to project from an opposite side 12b of the substrate. Contact portion or end 20 moves out of its opening or cutout 28 (FIG. 9A) so that it projects upwardly from side 12a of the substrate. It should be noted that a portion 40 of the flat flexible substrate still is attached to the back side of contact portion 20 of the terminal. That is why opening 28 was described in FIG. 9A as being a “cutout”. In other words, the cutout simply surrounds the contact portion, leaving portion 40 of the substrate adhered to the contact portion. The substrate material adds a spring force to the contact portion.

FIG. 9E shows a second substrate 42 adhered to the bottom of substrate 12A. This second substrate may also be of polyimide material and is effective to maintain fold 30 in substrate 12A.

FIG. 9F shows the final step in the process of attaching solder ball 22 to land portion or end 18 of the terminal. Of course, in a full device, there are numerous terminals and solder balls 22 to form a high density ball grid array (BGA).

In the second embodiment of device 10A in FIGS. 5-9F, terminals 16A preferably are fabricated of spring alloy metal material, such as beryllium copper or phosphor bronze. This provides spring characteristics for land end 18 and contact end 20 when they project from opposite sides of substrate 12A, thereby eliminating any additional or extraneous spring components as in the prior art.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An electrical device, comprising:
a flat flexible insulating substrate having an opening therethrough;
a flat conductive terminal deposited on one side of the substrate at said opening, a portion of the terminal being formed through the opening so that the terminal has opposite ends at opposite sides of the substrate, one end comprising a contact portion of the terminal and an opposite end comprising a land portion for receiving a solder ball.

2. The electrical device of claim 1 wherein one of said opposite ends of the terminal is located on said one side of the substrate adjacent the opening, and an opposite end of the terminal extends through the opening and projects away from an opposite side of the substrate.

3. The electrical device of claim 2 wherein said one end of the terminal on said one side of the substrate adjacent the opening comprises said land portion of the terminal.

4. The electrical device of claim 3 wherein said opposite end of the terminal extending through the opening comprises said contact portion of the terminal.

5. The electrical device of claim 1 wherein said terminal includes a central portion between the opposite ends thereof, the central portion being adhered to said one side of the substrate, and said opposite ends of the terminal projecting away from opposite sides of the substrate.

6. The electrical device of claim 5 wherein said flexible substrate is folded in an area of said central portion adjacent an edge of the opening to cause one end of the terminal to project from said one side of the substrate and an opposite end of the terminal to project through the opening beyond an opposite side of the substrate.

7. The electrical device of claim 6, including a second flat substrate adhered to said flat flexible substrate to maintain said folded area.

8. The electrical device of claim 5 wherein the end of the terminal projecting from said one side of the substrate comprises said contact portion of the terminal.

9. The electrical device of claim 8 wherein said opposite end of the terminal extends through the opening and comprises said land portion of the terminal.

10. The electrical device of claim 1 wherein said contact portion of the terminal is bifurcated to provide redundant contact means.

11. The electrical device of claim 1, including a solder ball attached to said land portion of the terminal.

12. The electrical device of claim 1 wherein at least the one end of the terminal comprising said contact portion is fabricated of spring alloy metal material.

13. A method of fabricating an electrical device, comprising the steps of:
providing a flat flexible insulating substrate;
depositing a flat conductive terminal on one side of the substrate, with the terminal having opposite ends;
removing a portion of the substrate to form an opening beneath at least one end of the terminal; and
forming said at least one end of the terminal through the opening so that opposite ends of the terminal are located at opposite sides of the substrate.

14. The method of claim 13, including fabricating said one end of the terminal with multi-metallic thicknesses of different stress coefficients so that the one end bends through the opening automatically on removing said portion of the substrate to form the opening.

15. The method of claim 13, including forming said one end of the terminal as a contact portion of the terminal.

16. The method of claim 15, including forming an opposite end of the terminal as a land portion on said one side of the substrate for receiving a solder ball.

17. The method of claim 13, including removing a portion of the substrate to form a second opening beneath an opposite end of the terminal, and forming said opposite end of the terminal so that it projects from said one side of the substrate.

18. The method of claim 17, including forming said opposite end of the terminal as a contact portion of the terminal.

19. The method of claim 18, including forming said one end of the terminal as a land portion for receiving a solder ball.

20. A method of fabricating an electrical device, comprising the steps of:
providing a flat flexible insulating substrate;
depositing a flat conductive terminal on one side of the substrate, with the terminal having opposite ends and a central portion between the opposite ends;
removing portions of the substrate for form openings about the opposite ends of the terminal; and
folding the flat flexible substrate in an area of the central portion of the terminal to cause the opposite ends of the terminal to move through the openings and project from opposite sides of the substrate.

21. The method of claim 20, including fabricating said terminal of a spring alloy metal material.

22. The method of claim 20, including providing a second flat substrate adhered to said flat flexible substrate to maintain the flat flexible substrate in folded condition.

23. The method of claim 20, including the step of attaching a solder ball to one end of the terminal.

24. The method of claim 20, including forming one end of the terminal as a contact portion of the terminal.

25. The method of claim 24, including forming the opposite end of the terminal as a land for receiving a solder ball.

26. The method of claim 24, including leaving a portion of the flat flexible substrate behind the contact end of the terminal to increase its spring characteristics.
